(19) United States
(12) Patent Application Publication
(10) Pub. No.: US 2011/0085000 A1
(43) Pub. Date: Apr. 14, 2011

(54) PRINTING APPARATUS AND PRINTING METHOD

(75) Inventors: Naoki Sudo, Matsumoto-shi (JP); Mai Kubota, Shiojiri-shi (JP); Akito Sato, Matsumoto-shi (JP); Tomohiro Yuda, Minowa-machi (JP); Takahide Miyashita, Shiojiri-shi (JP); Bunji Ishimoto, Matsumoto-shi (JP)

(73) Assignee: SEIKO EPSON CORPORATION, Tokyo (JP)

(21) Appl. No.: 12/897,888

(22) Filed: Oct. 5, 2010

(30) Foreign Application Priority Data
Oct. 14, 2009 (JP) 2009-237534

(51) Int. Cl. B41J 29/38

(52) U.S. Cl. 347/14

(57) ABSTRACT

There is provided a technique for suppressing the image quality of a printed image. A printing apparatus including: a first nozzle row in which nozzles ejecting dye ink of a certain color are arranged in a predetermined direction; a second nozzle row in which nozzles ejecting pigment ink of the certain color are arranged in the predetermined direction.

### BACKGROUND

1. Technical Field

The present invention relates to a printing apparatus and a printing method.

2. Related Art

As a printing apparatus including nozzles ejecting dye ink and nozzles ejecting pigment ink with the same color as that of the dye ink, there is known an ink jet printing apparatus including nozzles ejecting black dye ink to print a high-quality color image on an dedicated sheet and nozzles ejecting black pigment ink to clearly print, particularly, characters on a plain sheet (for example, see JP-A-2000-225719). Such an ink jet printing apparatus repeats an operation of transporting a medium in a transport direction and an operation of ejecting ink from nozzles while moving a head, in which a nozzle row ejecting dye ink and a nozzle row ejecting pigment ink are arranged in a movement direction intersecting the transport direction of the medium, in the movement direction.

When an image is formed by ejecting both the dye ink and the pigment ink while the head is reciprocated in the movement direction, the order of the ink ejected toward predetermined positions of the medium is reversed during the forward movement time of the head compared to the backward movement time of the head. When the order of the ink ejected is reversed, a problem may arise in that the hues or densities between portions printed at the forward movement time and portions printed at the backward movement time may become different from each other, an unevenness or a stripe pattern may occur in the printed image, and thus image quality may deteriorate.

### SUMMARY

An advantage of some aspects of the invention is that it provides a printing apparatus and a printing method capable of suppressing deterioration in the image quality of a printed image.

According to an aspect of the invention, there is provided a printing apparatus including: a first nozzle row in which nozzles ejecting dye ink of a certain color are arranged in a predetermined direction; a second nozzle row in which nozzles ejecting pigment ink of the certain color are arranged in the predetermined direction; and a control unit repeating an ejection operation of ejecting ink from the nozzles while moving the first and second nozzle rows relative to a medium in a movement direction intersecting the predetermined direction and a transport operation of moving the first and second nozzle rows relative to the medium in the predetermined direction to print an image in which a first image formed at a predetermined position on the medium by ejecting the dye ink and then ejecting the pigment ink while moving the first and second nozzle rows relative to the medium from one side to the other side of the movement direction and a second image formed at a position on the medium different from the predetermined position ejecting the pigment ink and then ejecting the dye ink while moving the first and second nozzle rows relative to the medium from the other side to the one side of the movement direction are alternately arranged in the predetermined direction and in which an end portion of the first image overlaps with an end portion of the second image.

Other aspects of the invention are apparent from the description of the specification and the accompanying drawings.

### BRIEF DESCRIPTION OF THE DRAWINGS

The invention will be described with reference to the accompanying drawings, wherein like numbers reference like elements.

FIG. 1A is a block diagram illustrating the overall configuration of a printing system in which a printer and a computer are connected to each other.

FIG. 1B is a schematic perspective view illustrating the printer.

FIG. 2 is a diagram illustrating the arrangement of nozzles formed on the lower surface of a head.

FIG. 3 is a diagram illustrating a printing method according to a comparative example.

FIG. 4A is a diagram illustrating a difference in the hue of a printed image.

FIG. 4B is a diagram illustrating a difference in the density of the printed image.

FIG. 5 is a diagram illustrating a printing method according to an embodiment of the invention.

### DESCRIPTION OF EXEMPLARY EMBODIMENTS

At least the following aspects of the invention are apparent from the description of the specification and the accompanying drawings.

According to an aspect of the invention, there is provided a printing apparatus including: a first nozzle row in which nozzles ejecting dye ink of a certain color are arranged in a predetermined direction; a second nozzle row in which nozzles ejecting pigment ink of the certain color are arranged in the predetermined direction; and a control unit repeating an ejection operation of ejecting ink from the nozzles while moving the first and second nozzle rows relative to a medium in a movement direction intersecting the predetermined direction and a transport operation of moving the first and second nozzle rows relative to the medium in the predetermined direction to print an image in which a first image formed at a predetermined position on the medium by ejecting the dye ink and then ejecting the pigment ink while moving the first and second nozzle rows relative to the medium from one side to the other side of the movement direction and a second image formed at a position on the medium different from the predetermined position ejecting the pigment ink and then ejecting the dye ink while moving the first and second nozzle rows relative to the medium from the other side to the one side of the movement direction are alternately arranged in the predetermined direction and in which an end portion of the first image overlaps with an end portion of the second image.

According to the printing apparatus, the join between the first and second images can scarcely be noticed, thereby suppressing deterioration in image quality.

In the printing apparatus according to the above aspect of the invention, a usage rate of the first nozzle row and a usage rate of the second nozzle row for forming an overlapping image in which an end portion of the first image overlaps with an end portion of the second image may be adjusted such that a density of the overlapping image is set to a density between a density of the first image and a density of the second image.

According to the printing apparatus, the join between the first and second images can scarcely be noticed, thereby suppressing deterioration in image quality.

In the printing apparatus according to the above aspect of the invention, a usage rate of the first nozzle row and a usage rate of the second nozzle row for forming an overlapping image in which an end portion of the first image overlaps with an end portion of the second image may be adjusted such that a hue of the overlapping image is set to a hue between a hue of the first image and a hue of the second image.

According to the printing apparatus, the join between the first and second images can scarcely be noticed, thereby suppressing deterioration in image quality.

In the printing apparatus according to the above aspect of the invention, the usage rate of the first nozzle row for forming an image part of the first image side in the overlapping image may be higher than the usage rate of the first nozzle row for forming an image part of the second image side in the overlapping image. The usage rate of the second nozzle row for forming an image part of the second image side in the overlapping image may be higher than the usage rate of the second nozzle row for forming an image part of the first image side in the overlapping image.

According to the printing apparatus, since a variation in the density and hue of the overlapping image can be made smooth, the join between the first and second images can scarcely be noticed.

In the printing apparatus according to the above aspect of the invention, a dot line belonging to the overlapping image and formed in the movement direction may be formed by the nozzles belonging to the first nozzle row in a certain ejection operation and the nozzles belonging to the second nozzle row in another ejection operation.

According to the printing apparatus, the dot can be formed at the position at which the dot has to be formed, even when the difference in the usage rates of the nozzle rows is large.

According to another aspect of the invention, there is provided a printing method including repeating an ejection operation of ejecting ink from nozzles while moving a first nozzle row in which the nozzles ejecting dye ink of a certain color are arranged in a predetermined direction and a second nozzle row in which the nozzles ejecting pigment ink of the certain color are arranged in the predetermined direction relative to the medium in the movement direction and a transport operation of moving the first and second nozzle rows relative to the medium in the predetermined direction; and printing an image in which a first image formed at a predetermined position on the medium while moving the first and second nozzle rows relative to the medium from one side to the other side of the movement direction and then ejecting the pigment ink and a second image formed at a position on the medium different from the predetermined position while moving the first and second nozzle rows relative to the medium from the other side to the one side of the movement direction and then ejecting the dye ink are alternately arranged in the predetermined direction and in which an end portion of the first image overlaps with an end portion of the second image.

According to the printing apparatus, the join between the first and second images can scarcely be noticed, thereby suppressing deterioration in image quality.

### Printing System

An example in which an ink jet printer (hereinafter, referred to as a printer) is used as an example of a printing apparatus and a printing system includes the printer and computer connected to each other will be described.

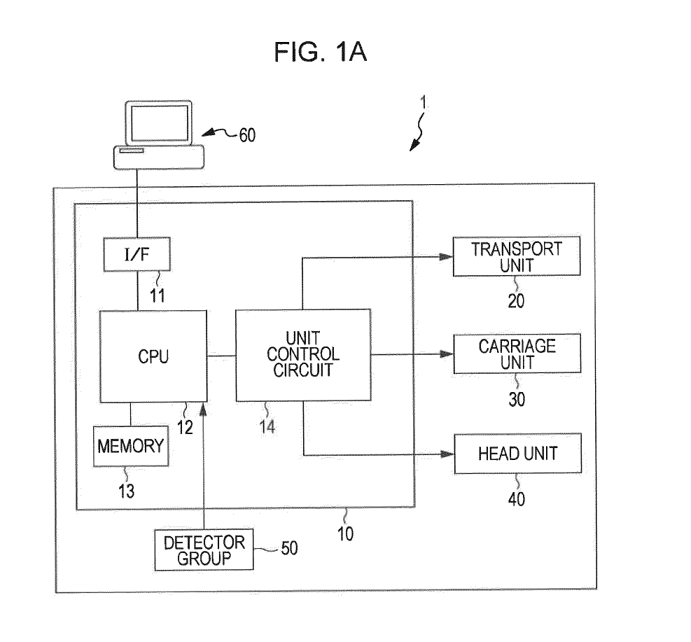

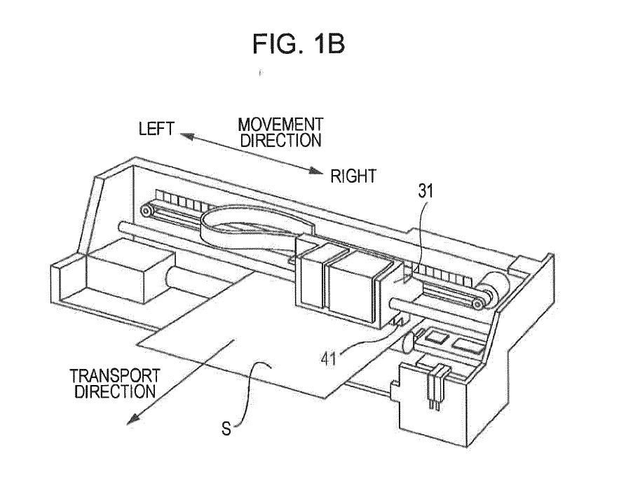

FIG. 1A is a block diagram illustrating the overall configuration of the printing system in which a printer 1 and a computer 60 are connected to each other. FIG. 1B is a schematic perspective view illustrating the printer 1. In the printer 1 receiving print data from the computer 60, which is an external apparatus, a controller 10 controls units (a transport unit 20, a carriage unit 30, and a head unit 40) to form an image on a sheet S (medium). A detector group 50 monitors the status of the printer 1 so that the controller 10 controls the respective units based on the detection result.

The controller 10 (control unit) is a unit that controls the printer 1. An interface 11 is a unit that transmits and receives data between the computer 60, which is an external apparatus, and the printer 1. A CPU 12 is an arithmetic processing unit that controls the entire printer 1. A memory 13 is a unit that guarantees an area storing a program of the CPU 12 or a work area. The CPU 12 permits a unit control circuit 14 to control the respective units. The transport unit 20 is a unit that transports the sheet S to a printable location and then transports the sheet S by a predetermined transport amount in the transport direction at the printing time. The carriage unit 30 is a unit that moves a head 41 in a direction (hereinafter, referred to as a movement direction) intersecting the transport direction. The head unit 40 is a unit that ejects ink toward the sheet S and includes the head 41.

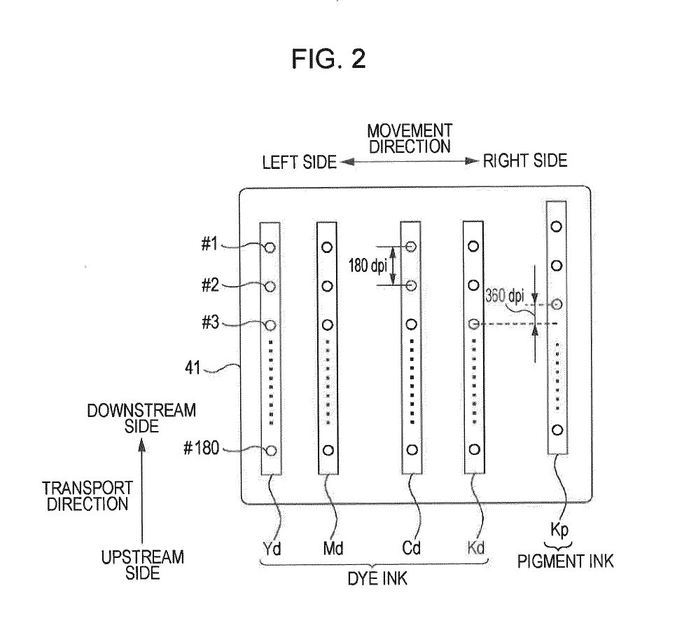

FIG. 2 is a diagram illustrating the arrangement of nozzles formed on the lower surface of the head 41. The plurality of nozzles ejecting ink is formed on the lower surface of the head 41. Each of the nozzles includes a pressure chamber (not shown) storing ink and a piezoelectric element (driving element) varying the volume of the pressure chamber to eject the ink. The printer 1 according to this embodiment can eject yellow, magenta, cyan, and black dye ink and black pigment ink. Therefore, a yellow nozzle row Yd ejecting the yellow dye ink, a magenta nozzle row Md ejecting the magenta dye ink, a cyan nozzle row Cd ejecting the cyan dye ink, a black nozzle row Kd ejecting the black dye ink, and a black pigment nozzle row Kp ejecting the black pigment ink are formed on the lower surface of the head 41 shown in FIG. 2.

Each of the nozzle rows includes 180 nozzles (#1 to #180). Smaller numbers (#1 to #180) are sequentially attached to the nozzles from the nozzles located on the downstream side of the transport direction among the nozzles belonging to each nozzle row. The nozzles of each nozzle row are arranged in a constant interval (180 dpi) in the transport direction (predetermined direction). The dye ink nozzles rows (Yd, Md, Cd, and Kd) for the four colors are located at the same positions in the transport direction. However, the dye ink nozzle rows for the four colors and the black pigment nozzle row Kp are separated from each other in the position in the transport direction by the half (360 dpi) of the nozzle pitch. For example, nozzle #1 on the furthest downstream side of the black pigment nozzle row Kp is located on the downstream side of the transport direction by the half of the nozzle pitch with respect to nozzle #1 on the most downstream of the black dye nozzle row Kd.

The printer 1 repeats a dot forming operation of intermittently ejecting ink from the head 41 being moving in the movement direction to form dot lines (raster lines) on the sheet S in the movement direction and a transport operation of transporting the sheet S in the transport direction. As a consequence, dots can be formed at positions different from the positions of the dots formed in the previous dot forming operation, thereby printing a two-dimensional image on the sheet S. Hereinafter, a one-time operation (image forming operation) of forming an image while moving the head 41 in the movement direction is called a “pass (ejection operation)”.

### Dye Ink and Pigment Ink

The printer 1 can eject two kinds of black ink (dye ink and pigment ink). The dye ink has a characteristic in which a glossy image can be printed, but the dye ink can easily be blurred. On the contrary, the pigment ink has a characteristic in which a blurred phenomenon scarcely occurs and black tone can be expressed strongly (darkly), but a glossy image can only be expressed with difficulty since a color material sits on the surface of a medium. The black dye ink and the black pigment ink used in the printer 1 according to this embodiment are the same black, but are different in hue. The black dye ink has a hue (black) biased toward cyan, whereas the black pigment ink has a hue (black) biased toward magenta.

The printer 1 uses the black pigment ink Kp, when the printer 1 prints a black text image (when the printer 1 prints an image on a plain sheet). Then, characters can be prevented from being broken due to the blurring, thereby printing an easily-read text document with a high black density. On the contrary, when a color image such as a photo is printed (when an image is printed on a glossy sheet), the printer 1 uses the black dye ink Kd (and the color dye ink Yd, Md, and Cd). Then, a glossy image can be printed.

On a plain sheet on which a image is printed, not only an image can be printed using the pigment ink, but also an image can be printed using the dye ink. On the other hand, when an image is printed using the pigment ink on a glossy sheet, the color material of the pigment ink sits on the surface of the medium. Therefore, unevenness occurs on the surface of the image, and thus a glossy image may not be printed. That is, the pigment ink is not suitable as ink used for printing an image on a glossy sheet.

When the printer 1 performs monochrome printing on a plain sheet (when a monochrome text image is printed), a user can set a “clear mode” or a “fast mode”. The black ink to be used is changed depending on the mode selected by the user. When the “clear mode” is selected, only the black pigment nozzle row Kp is used for printing an image. Then, it is possible to print a black text document with has a high density and with no blurring.

On the other hand, when the “fast mode” is selected, an image is printed using both the black pigment nozzle row Kp and the black dye nozzle row Kd. Then, since an image can be printed using the two rows of the black pigment nozzle row Kp and the black dye nozzle row Kd, the number of nozzles used for printing an image increases, thereby shortening a print time. Since the black pigment nozzle row Kp and the black dye nozzle row Kd are separated from each other in position in the transport direction by the half of the nozzle pitch in the head 41 shown in FIG. 2, a high-resolution image can be printed rapidly. The invention is not limited to the case in which the monochrome printing is performed on a plain sheet. When not only the monochrome printing is performed on a plain sheet but also an image including black is printed on a plain sheet, whether only the black pigment nozzle row Kp is used or both the black pigment nozzle row Kp and the black dye nozzle row Kd are used may be selected depending on the mode.

### Printing Method According to Comparative Example

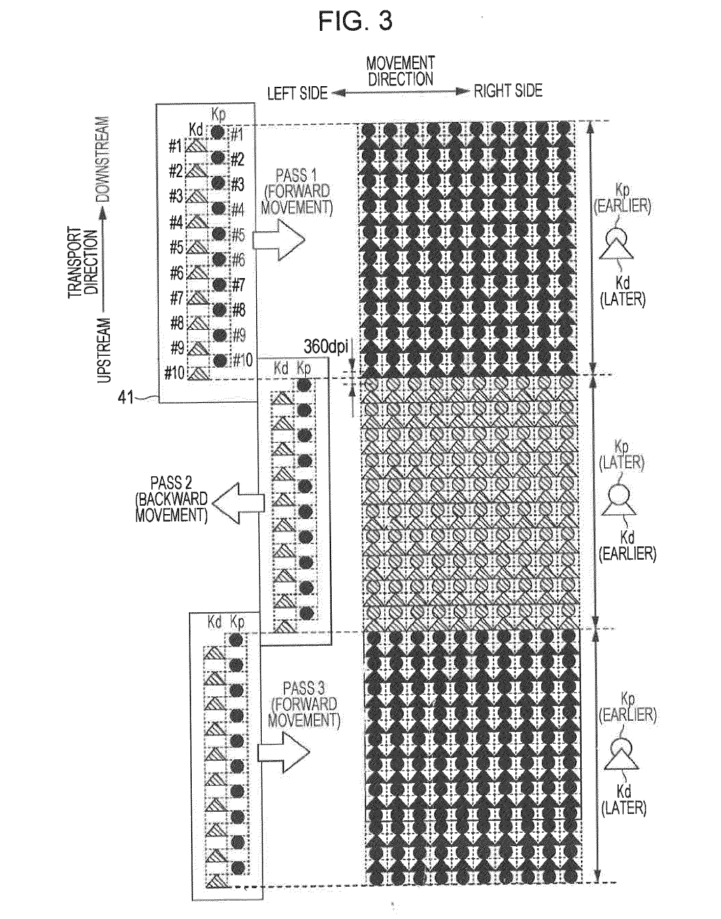

FIG. 3 is a diagram illustrating a printing method according to a comparative example. In FIG. 3, the “fast mode” is selected and a black image is printed using both the black pigment nozzle row Kp and the black dye nozzle row Kd. For facilitating description, ten nozzles are illustrated for each nozzle row in the head 41 in the drawing, the nozzles of the black pigment nozzle row Kp are indicated by the black circle, and the nozzles of the black dye nozzle row Kd are indicated by a diagonal-line triangle. In the actual printer 1, the medium is transported in the transport direction with respect to the head 41. However, in the drawing, the head 41 is moved in the transport direction. The printer 1 according to this embodiment performs “bi-directional printing” to form an image not only when the head 41 is moved from the left side to the right side of the movement direction (at the forward movement time), but also when the head 41 is moved from the right side to the left side of the movement direction (at the backward movement time).

A print resolution in the transport direction is set to “360 dpi”. When the black pigment nozzle row Kp and the black dye nozzle row Kd are lined up in the head 41 shown in FIG. 2, the nozzles ejecting the black ink are arranged at an interval of 360 dpi in the transport direction. Therefore, even when the printing is performed using both the black pigment nozzle row Kp and the black dye nozzle row Kd, a band image with a print resolution of 360 dpi in the transport direction can be printed by one-time pass (one-time movement in the movement direction) of the head 41. Therefore, in the printing method according to the comparative example shown in FIG. 3, the medium is transported in the transport direction by the width of the band image printed at pass 1, that is, the length in which the black pigment nozzle row Kp and the black dye nozzle row Kd are lined up, after the band image is printed at pass 1. Then, a gap between a raster line (which is a dot line in the movement direction) on the furthest upstream side in the band image printed at pass 1 and a raster line on the furthest downstream side in a band image printed at pass 2 can be set to “360 dpi”.

In the head 41 according to this embodiment, the black dye nozzle row Kd is located on the left side in the movement direction with respect to the black pigment nozzle row Kp. Therefore, since the black pigment nozzle row Kp faces the medium earlier than the black dye nozzle row Kd at the forward movement time (when the head is moved from the left side to the right side of the movement direction), ink droplets ejected from the black pigment nozzle row Kp are landed on certain areas of the medium earlier than ink droplets ejected from the black dye nozzle row Kd. On the contrary, at the backward movement time (when the head is moved from the right side to the left side of the movement direction), the ink droplets from the black dye nozzle row Kd are landed on certain areas of the medium earlier than the ink droplets ejected from the black pigment nozzle row Kp. That is, the order in which the black pigment ink and the black dye ink are landed on the medium is different at the forward movement time and the backward movement time.

In the right part of FIG. 3, dots are formed in pixels (grids in the drawing) set on the medium. The black pigment dots are indicated by a circle and the black dye dots are indicated by a triangle. In the printing method according to the comparative example, the band image is completed by one-time pass. Therefore, one band image is formed by alternately arranging the raster line in which the black pigment dots (circles) are arranged in the movement direction and the raster line in which the black dye dots (triangles) are arranged in the movement direction. That is, in the printing method of performing the bi-directional printing according to the comparative example, the order in which the black pigment raster line and the black dye raster line are formed is different at the time forward movement time and the backward movement time. In the printing method according to the comparative example, the black pigment dots (circles) and the black dye dots (triangles) are formed in the transport direction. Therefore, the order in which the black pigment ink and the black dye ink are landed on the neighboring regions (the pixels arranged in the transport direction) on the medium is different at the forward movement time and the backward movement time. The dot with a size fitting for one pixel is illustrated in FIG. 3. However, in some cases, a dot is formed to be larger than one pixel in actual printing. Therefore, in some cases, the black pigment dots (parts thereof) and the black dye dots (parts thereof) arranged in the transport directions overlap with each other. Accordingly, the order in which the black pigment dots and the black dye dots overlap with each other is said to be different at the time forward movement time and the backward movement time.

The band image (the band image printed at the forward movement time) formed by ejecting the black pigment ink to the neighboring areas on the medium earlier than the black dye ink and the band image (band image printed at the backward movement time) formed by ejecting the black dye ink to the neighboring areas on the medium earlier than the black pigment ink are different in the hue or density, even when the same black image is printed. Specifically, in the image (the band image printed at the forward movement time) formed by ejecting the black pigment ink earlier, the hue is biased toward the black pigment ink and the density becomes higher. On the contrary, in the image (the band image printed at the backward movement time) formed by ejecting the black dye ink earlier, the hue is biased toward the black dye ink and the density becomes lower. As described above, the hue of the black dye ink is biased toward a cyan color and the hue of the back pigment ink is biased toward a magenta color. Accordingly, a black image biased toward the magenta color is printed in the image formed by ejecting the black pigment ink earlier, whereas a black image biased toward a cyan color is formed in the image formed by ejecting the black dye ink earlier.

This is because the black pigment ink and the black dye ink (the part of the ink is ejected in an overlapping manner) ejected to the neighboring areas at the same pass have an influence to each other. When the black pigment ink is ejected earlier to the sheet, the black pigment ink (coloring material/pigment component) sits on the surface of the medium. However, when the black pigment ink is ejected to the areas where the black dye ink has earlier been ejected, it is considered that the black pigment ink (coloring material/pigment component) sinks together with the black dye ink or diffuses together with the black dye ink. As a consequence, the hue is biased toward the black pigment ink (magenta color) and thus the density becomes higher in the image formed by ejecting the black pigment ink earlier, whereas the hue is biased toward the black dye ink (cyan color) and thus the density becomes lower in the image formed by ejecting the black dye ink earlier.

When the bi-directional printing is performed using both the black pigment ink and the black dye ink, the black pigment ink and the black dye ink are ejected to the neighboring areas on the medium at the same pass (in a short time). When the black pigment ink and the black dye ink have an influence on each other, the hue and the density of the image are different due to the landing order of the ink (depending on the forward movement time and the backward movement time).

Since the black pigment ink is ejected earlier at the forward movement time in the printing method (see FIG. 3) according to the comparative example, the hue is biased toward the black pigment ink (magenta color) and thus the density becomes higher in the band image printed at the forward movement time. In the right part of FIG. 3, the dots of the band image printed at the forward movement time are indicated by the black dots. On the contrary, since black dye ink is ejected earlier at the backward movement time, the hue is biased toward the black dye ink (cyan color) and thus the density becomes lower in the band image printed at the backward movement time. In the right part of FIG. 3, the dots of the band image printed at the backward movement time are indicated by diagonal-line dots. In the printing method according to the comparative example, the band image is printed at a one-time pass, and then the medium is transported by the width of the band image. Therefore, the band image formed at the previous pass and the band image formed at the next pass do not overlap with each other and are arranged in the transport direction. As a consequence, as shown in FIG. 3, the dark band image formed at the forward movement time and biased toward the magenta color (black pigment ink) and the light band image formed at the backward movement time and biased toward the cyan color (black dye ink) are alternately arranged in the transport direction. Then, the boundary line between the band image printed at the forward movement time and the band image printed at the backward movement time is noticed, thereby deteriorating the quality of the printed image.

When the printer 1 performs the bi-directional printing using both the pigment ink and the dye ink of the same color (black) according to this embodiment, an object is to make the boundary line between the image (the band image printed at the forward movement time) formed by ejecting the pigment ink earlier than the dye ink and the image (the band image printed at the backward movement time) formed by ejecting dye ink earlier than the pigment ink scarcely noticeable. That is, the object is to prevent the quality of the printed image from deteriorating.

### Printing Method According to Embodiment

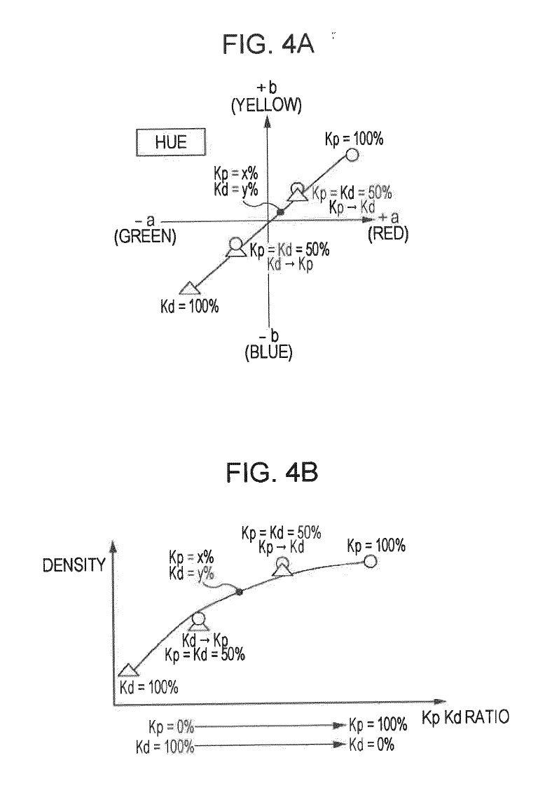

FIG. 4A is a diagram illustrating a difference in the hue (tone or tint) of a printed image. FIG. 4B is a diagram illustrating a difference in the density of the printed image. In FIG. 4A, a hue becomes closer to a red color, as the hue moves toward the right side (+a) of the horizontal axis. A hue becomes closer to a green color, as the hue moves toward the left side (−a) of the horizontal axis. A hue becomes closer to a yellow color, as the hue moves toward to the upper side (+b) of the vertical axis. A hue becomes closer to a blue color, as the hue moves toward a lower side (−b) of the vertical axis. In the printer 1 according to this embodiment, as described above, the hue of the black dye ink is set to be biased toward the cyan color and the color of the black pigment ink is set to be biased toward the magenta color. As shown in FIG. 4A, the hue (Kd=100%) of the image printed only with the black dye ink is plotted to the location biased toward the cyan color. The hue (Kp=100%) of the image printed using only the black pigment ink is plotted to the location biased toward the magenta color.

In the image printed using both the black dye ink and the black pigment ink in the bi-directional printing, the hue of the image becomes different depending on the landing order of the ink. Therefore, even in the image (Kp=Kd=50%) printed using the black dye ink and the black pigment ink at the same ratio, the hue (Kp→Kd) of the image formed by ejecting the black pigment earlier is biased toward the hue of the image (Kp=100%) printed using only the black pigment ink and is plotted to the position biased toward the magenta color, whereas the hue (Kd→Kp) of the image formed by ejecting the black dye ink earlier is biased toward the hue of the image (Kd=100%) printed using only the black dye ink and is plotted to the position biased toward the cyan color.

From the relationship diagram (see FIG. 4A), it can be known that the “hue of the image” can be adjusted by varying a usage rate y % of the black dye nozzle row Kd and a usage rate x % of the black pigment nozzle row Kp. For example, when an image is desired to be printed using the black pigment ink (magenta color), the usage rate of the black pigment nozzle row Kp is set to be higher than the usage rate of the black dye nozzle row Kd. Conversely, when an image is desired to be printed using the black dye ink (cyan color), the usage rate of the black dye-nozzle row Kd is set to be higher than the usage rate of the black pigment nozzle row Kp.

In the graph shown in FIG. 4B, the horizontal axis represents the usage rate of the black dye nozzle row Kd and the usage rate of the black pigment nozzle row Kp, and the vertical axis represents the density of the printed image. The “density” is measured by the light (reflection ratio) reflected from the image when the image is illuminated with light. When the reflected light is small, the density of the image is dark (high). When the reflected light is large, the density of the image is light (low). As the usage rate moves toward the left side of the horizontal axis, the usage rate of the black dye nozzle row Kd is high (100%) and the usage rate of the black pigment nozzle row Kp is low (0%). Conversely, as the usage rate moves toward the right side of the horizontal axis, the usage rate of the black dye nozzle row Kd is low (0%) and the usage rate of the black pigment nozzle row Kp is high (100%). As described above, the black dye ink is blurred less than the black pigment ink and can express the tone of the black darkly. As shown in FIG. 4B, the density of the image (Kp=100%) printed using only the black pigment ink is higher (darker) than the density of the image (Kd=100%) printed using only the black dye ink. As shown in FIG. 4B, the density of the image (Kd→Kp) formed by ejecting the black dye ink earlier than the black pigment ink is higher than the density of the image (Kd=100%) formed using only the black dye ink, but is lower than the density of the image (Kp→Kd) formed by ejecting the black pigment ink earlier than the black dye ink. Conversely, the density of the image (Kp→Kd) formed by ejecting the black pigment ink earlier than the black dye ink is lower than the density of the image (Kp=100%) formed using only the black pigment ink, but is higher than the image (Kd→Kp) formed by ejecting the black dye ink earlier than the black pigment ink.

From the relationship diagram (see FIG. 4B), it can be known that the “density of the image” can be adjusted by varying the usage rate y % of the black dye nozzle row Kd and the usage rate x % of the black pigment nozzle row Kp. For example, when it is desired to print an image with a high density, the usage rate of the black pigment nozzle row Kp is set to be higher than the usage rate of the black dye nozzle row Kd. Conversely, when it is desired to print an image with a low density, the usage rate of the black dye nozzle row Kd is set to be higher than the usage rate of the black pigment nozzle row Kp.

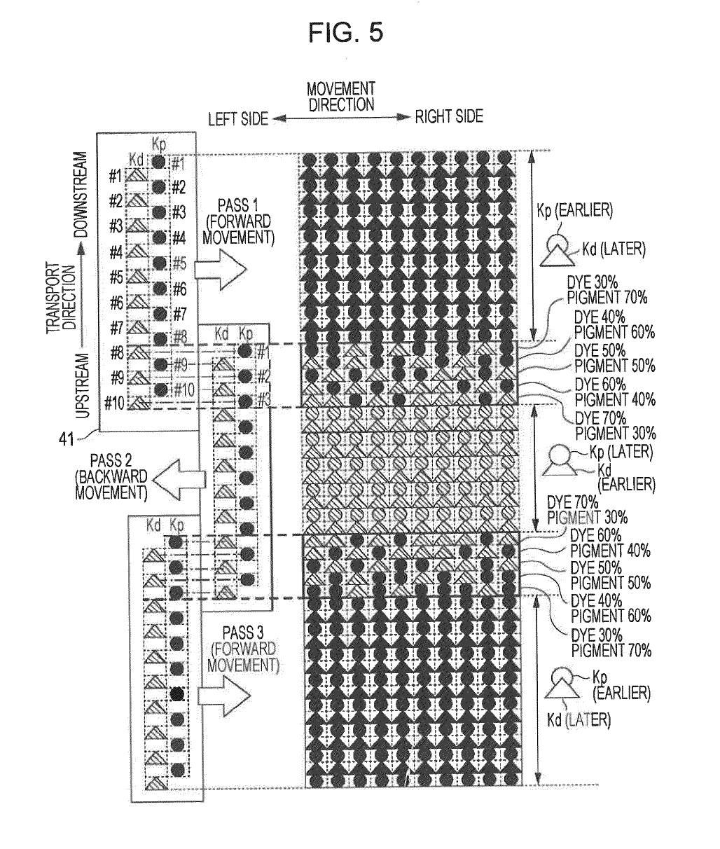

FIG. 5 is a diagram illustrating a printing method according this embodiment. In the drawing, the “fast mode” is selected and a black image is printed using both the black pigment nozzle row Kp (second nozzle row) and the black dye nozzle row Kd (first nozzle row). In the printing method (see FIG. 3) according to the above-described comparative example, the band image is printed at one-time pass, and then the medium is transported by the width of the band image. Therefore, the dark band image formed at the forward movement time and biased toward the magenta color (black pigment ink) and the light band image formed at the backward movement time and biased toward the cyan color (black dye ink) are alternately arranged in the transport direction. Then, in the printing method according to the comparative example, the boundary line between the band images is noticed, thereby deteriorating the quality of the printed image.

In the printing method according to this embodiment, an end portion of the band image (second image) printed at the forward movement time and an end portion of the band image (first image) printed at the backward movement time are printed in an overlapping manner. In a portion (hereinafter, referred to as an overlapping image) in which the end portion of the band image printed at the forward movement time and the end portion of the band image printed at the backward movement time, the portion to which the black pigment ink is ejected earlier than the black dye ink in the neighboring area and the portion to which the black dye ink is ejected earlier than the black pigment ink in the neighboring area coexist. Therefore, in the overlapping image, the bias to the hue and the density scarcely occurs due to the difference in the order in which the black pigment ink and the black dye ink are ejected. Therefore, the join between the band image printed at the forward movement time and the band image printed at the backward movement time can scarcely be noticed by forming the overlapping image between the band image printed at the forward movement time and the band image printed at the backward movement time.

According to this embodiment, the hue and the density of the overlapping image are adjusted based on “the relationship diagram between the usage rate and the hue of the black dye nozzle row Kd and the black pigment nozzle row Kp” shown in FIG. 4A and “the relationship diagram between the usage rate and the density of the black dye nozzle row Kd and the black pigment nozzle row Kp” shown in FIG. 4B. In order to make the join between the band image printed at the forward movement time and the band image printed at the backward movement time scarcely noticeable, the usage rates of the black dye nozzle row Kd and the black pigment nozzle row Kp for printing the overlapping image are adjusted so that the hue of the overlapping image is set to a hue between the hue of the image printed at the forward movement time and the hue of the image printed at the backward movement time and the density of the overlapping image is set to a density between the density of the image printed at the forward movement time and the density of the image printed at the backward movement time. Thus, the join between the band image printed at the forward movement time and the band image printed at the backward movement time can be made scarcely noticeable, thereby preventing the quality of the printed image from deteriorating.

According to this embodiment, when the hue and the density of the overlapping image are adjusted, the amount of ink ejected to form the overlapping image is not adjusted, but the usage rates of the black dye nozzle row Kd and the black pigment nozzle row Kp are adjusted. If the amount of ejected ink is adjusted by adjusting the hue and the density of the overlapping image, the dots constituting the overlapping image are thinned out in the overlapping image desired to be printed lightly, thereby deteriorating filling of the medium. When the overlapping image with a dark tone of the black is desired to be printed, there is a limitation in the black dye ink in expressing the tone of the black even though the amount of ejected black dye ink is increased. In this embodiment, however, dots can be formed at the positions indicated by the image data by increasing the usage rate of the black dye nozzle row Kd without thinning out dots, when the overlapping image is desired to be printed lightly. Moreover, the hue (the tone of the black) of the image can be adjusted by increasing the usage rate of the black pigment nozzle row Kp, when the tone of the black of the overlapping image is desired to be printed lightly.

Hereinafter, the printing method according to this embodiment will be described in detail with reference to FIG. 5. In FIG. 5, for facilitating description, ten nozzles are illustrated for each nozzle row. The print resolution in the transport direction is set to 360 dpi. In the nozzle rows of the black pigment nozzle row Kp and the black dye nozzle row Kd, five nozzles on the upstream side in the transport direction at the previous pass overlap with five nozzles on the downstream side in the transport direction at the next pass to print an image. For example, an image formed by two nozzles #9 and #10 of the black pigment nozzle row Kp on the upstream side and three nozzles #8, #9, and #10 of the black dye nozzle row Kd on the upstream side at pass 1 overlaps with an image formed by three nozzles #1, #2, and #3 of the black pigment nozzle row Kp on the downstream side and two nozzles #1 and #2 of the black dye nozzle row Kd on the downstream side at pass 2. Therefore, in the printing method according to this embodiment, the transported distance of the medium is shortened by the width of the image printed by the five nozzles in one-time transport operation, compared to the printing method according to the comparative example. By adjusting the usage rate of the nozzles for the black dye ink and the usage rate of the nozzles for the black pigment ink for printing the overlapping image, the hue and density of the overlapping image are set to have values between the hues and densities of the band images printed at the forward movement time and the backward movement time, respectively.

In this embodiment, it is assumed that two nozzles forming one raster line (dot line in the movement direction) belonging to the overlapping image are a nozzle of the black dye nozzle row Kd and a nozzle of the black pigment nozzle row Kp. For example, nozzle #8 of the black dye nozzle row Kd at pass 1 and nozzle #1 of the black pigment nozzle row Kp at pass 2 form one raster line. In addition, nozzle #9 of the black pigment nozzle row Kp at pass 1 and nozzle #1 of the black dye nozzle row Kd at pass 2 form one raster line. Therefore, in this embodiment, the hue and the density of the overlapping image are adjusted by forming one raster line according to the usage rate of the black dye nozzle row Kd and the usage rate of the black pigment nozzle row Kp. Forming one raster line according to the usage rate of the black dye nozzle row Kd and the usage rate of the black pigment nozzle row Kp means that a ratio of the number of black dye dots to the number of black pigment dots among dots constituting one raster line is set to a ratio of the usage rate of the black dye nozzle row Kd to the usage rate of the black pigment nozzle row Kp. For example, when the usage rate of the black dye nozzle row Kd is set to 40% and the usage rate of the black pigment nozzle row Kp is set to 60% to form the overlapping image, 40 dots are dots of the black dye ink and 60 dots are dots of the black pigment ink among 100 dots constituting one raster line. Alternatively, it can be said that the ink of 40% is the black dye ink and the ink of 60% is the black pigment ink among the amount of ink ejected to form one raster line.

As described above, the hue and density of the image are different depending not only on the usage rate of the black dye nozzle row Kd and the usage rate of the black pigment nozzle row Kp but also on the ejection order of the black dye ink and the black pigment ink. In the overlapping image, however, the bias to the hue and the density scarcely occurs due to the difference in the ejection order of the black dye ink and the black pigment ink, since the image (the portion to which the black pigment ink is ejected earlier) printed at the forward movement time and the image (the portion to which the black dye ink is ejected earlier) printed at the backward movement time coexist. Moreover, in the printing method shown in FIG. 5, the raster line in the movement direction is formed by two nozzles at different passes. Therefore, the dots adjacent to each other in the movement direction scarcely affect each other even when either the black pigment ink or the black dye ink is ejected earlier. For example, even in a raster line formed by ejecting the black dye ink earlier, the black dye dots and the black pigment dots are formed at different passes in the overlapping image. Thus, the black dye dots are being dried when the black pigment dots are formed near the black dye dots. Therefore, it is considered that the degree to which the black pigment ink (coloring material) sinks together with the black dye ink is small. Accordingly, the ejection order of the ink has a small influence on the hue and density of the image. The usage rate of the black dye nozzle row Kd and the usage rate of the black pigment nozzle row Kp has a large influence on the hue and density of the image.

Accordingly, for dots out of the overlapping image, the influence of the ejection order of the ink has to be taken into consideration. In FIG. 5, dots belonging to an image (darkly printed image) printed at the forward movement time by ejecting the pigment ink earlier are indicated by a black dot irrespective of the dye dots and the pigment dots, and dots belonging to an image (lightly printed image) printed at the backward movement time by ejecting the dye ink earlier are indicated by a diagonal line dot irrespective of the dye dots and the pigment dots. For the dots inside the overlapping image (inside the heavy-line range), the tone of each ink has to be taken into consideration. The black pigment dots are indicated by a black dot and the black dye dots are indicated by a diagonal-line dot. In FIG. 5, it can be known that the boundary line between the image printed at the forward movement time and the image printed at the backward movement is scarcely noticeable by forming the overlapping image, compared to the printing method (see FIG. 3) according to the comparative example.

In the printing method according to this embodiment, the usage rate of the black dye nozzle row Kd and the usage rate of the black pigment nozzle row Kp are varied even in the overlapping image. In FIG. 5, for example, the hue and the density of the overlapping image have the average value of the hues and the average value of the densities of the band images printed at the forward movement time and the backward movement time by setting both the usage rate of the black dye nozzle row Kd and the usage rate of the black pigment nozzle row Kp to 50%. Both the usage rate of the black dye nozzle row Kd and the usage rate of the black pigment nozzle row Kp for forming a middle raster line (third line from the downstream side) in the transport direction among the raster lines belonging to the overlapping image (within the heavy-line range of the drawing) at pass 1 and pass 2 are set to 50%.

The usage rate of the black pigment nozzle row Kp forming the raster line close to the image (the image formed by ejecting the black pigment ink earlier) printed at the forward movement time, that is, the image with the high density of the magenta color among the raster lines belonging to the overlapping image is set to be higher than the average usage rate of the black pigment nozzle row Kp forming the middle raster line of the overlapping image. Conversely, the usage rate of the black dye nozzle row Kd forming the raster line close to the image printed at the backward movement time in the overlapping image is set to be lower than the average usage rate of the black dye nozzle row Kd forming the middle raster line of the overlapping image. In FIG. 5, the usage rate (for example, 70%) of the black pigment nozzle row Kp forming the raster line on the furthest downstream side among the raster lines belonging to the overlapping image at pass 1 and pass 2 is set to be higher than the average usage rate (for example, 50%) of the black pigment nozzle row Kp forming the middle raster line of the overlapping image. In addition, the usage rate (for example, 30%) of the black dye nozzle row Kd forming the raster line on the furthest downstream side is set to be lower than the average usage rate (for example, 50%) of the black dye nozzle row Kd forming the middle raster line.

On the other hand, the usage rate of the black pigment nozzle row Kp forming the raster line close to the image (the image formed by ejecting the black dye ink earlier) printed at the backward movement time, that is, the image with the low density of the cyan color among the raster lines belonging to the overlapping image is set to be lower than the average usage rate of the black pigment nozzle row Kp forming the middle raster line of the overlapping image. The usage rate of the black dye nozzle row Kd forming the raster line close to the image printed at the backward movement time is set to be higher than the average usage rate of the black dye nozzle row Kd forming the middle raster line of the overlapping image. In FIG. 5, the usage rate (for example, 30%) of the black pigment nozzle row Kp forming the raster line on the furthest upstream side among the raster lines belonging to the overlapping image at pass 1 and pass 2 is set to be lower than the usage rate (for example, 50%) of the black pigment nozzle row Kp forming the middle raster line of the overlapping image. In addition, the usage rate (for example, 70%) of the black dye nozzle row Kd forming the raster line on the furthest upstream side is set to be higher than the average usage rate (for example, 50%) of the black dye nozzle row Kd forming the middle raster line. The overlapping image at pass 1 and pass 2 and the overlapping image at pass 2 and pass 3 are opposite to each other in the usage rate of the black dye nozzle row Kd and the usage rate of the black pigment nozzle row Kp.

In this embodiment, the usage rate of the black pigment nozzle row Kp is set to be higher and the usage rate of the black dye nozzle row Kd is set to be lower, as the raster line is closer to the image (the image printed at the forward movement time) formed by ejecting the black pigment ink earlier among the raster lines belonging to the overlapping image. Conversely, the rate use of the black pigment nozzle row Kp is set to be lower and the rate use of the black dye nozzle row Kd is set to be higher, as the raster line is closer to the image (the image printed at the backward movement time) printed by ejecting the black dye ink earlier among the raster lines belonging to the overlapping image. As a consequence, the hue can gradually be varied from the magenta color to the cyan color to make the density lighter gradually, when the dark image of the magenta color printed at the forward movement time is transited to the light image of the cyan color printed at the backward movement time. Conversely, the hue can be gradually varied from the cyan color to the magenta color to make the density gradually darker, when the light image of the cyan color printed at the backward movement time is transited to the dark image of the magenta color printed at the forward movement time. That is, since the hue and the density of the overlapping image can be varied smoothly, the join between the images can scarcely be noticed.

In this embodiment, the number of black pigment dots and the number of black dye dots in the overlapping image are adjusted to adjust the hue and the density of the overlapping image. However, preferably, the dots of each ink can be formed in a dispersed manner. Then, the dark portion of the magenta color in which the black pigment dots are mainly formed or the light portion of the cyan color in which the black dye dots are mainly formed in the overlapping image can be prevented from being formed, thereby suppressing deterioration in the image quality. In FIG. 5, for example, in the raster line in which the black pigment dots (circle) are more numerous than the black dye dots (triangle), the black dye dots are not continuously formed in the movement direction but are formed at the interval of the predetermined number of dots.

In order to change the usage rate of the black dye nozzle row Kd and the usage rate of the black pigment nozzle row Kp in every raster line, as shown in FIG. 5, one raster line needs to be formed by two kinds of black dye and black pigment nozzles. When one raster line belonging to the overlapping image is formed by the same kind of two nozzles (for example, two black dye nozzles), the raster line to which the black dye nozzle is assigned and the raster line to which the black pigment nozzle is assigned are alternately arranged in the transport direction. Therefore, the usage rate of the black dye nozzle row Kd and the usage rate of the black pigment nozzle row Kp can be changed in every two raster lines. When a difference between the usage rate of the black dye nozzle row Kd and the usage rate of the black pigment nozzle row Kp is large, filling of the dots of the raster line to which the nozzle row of the low usage rate is assigned may deteriorate. Then, the dots may not be formed at the pixels in which the dot is formed based on the image data. Accordingly, preferably, the transported distance of the medium is adjusted in the one-time transport operation so that both the black dye nozzle and the black pigment nozzle are assigned to the raster lines belonging to the overlapping image. In this way, even though the difference between the usage rate of the black dye nozzle row Kd and the usage rate of the black pigment nozzle row Kp is large, the dots can be formed at the pixels in which the dot is formed.

To sum up, in this embodiment, the end portion of the image printed at the forward movement time overlaps with the end portion of the image printed at the backward movement time, when the bi-directional printing is performed using the black dye nozzle row Kd and the black pigment nozzle row Kp at the same pass. The usage rate of the black dye nozzle row Kd and the usage rate of the black pigment nozzle row Kp are adjusted such that the hue and density of the image formed by overlapping the end portions are set to have the values between the hues and densities of the band images printed at the forward movement time and the backward movement time, respectively. Thus, even when the image printed at the forward movement time and the image printed at the backward movement time are different from each other in the hue and the density due to the different orders in which the black dye ink and the black pigment ink are landed at the forward movement time and the backward movement time, the join between the image printed at the forward movement time and the image printed at the backward movement time can scarcely be noticed. Moreover, the usage rate of the black pigment ink is set to be higher in the raster line close to the image printed by ejecting the black pigment ink earlier than in the raster line close to the image printed by ejecting the black dye ink earlier. The usage rate of the black dye ink is set to be higher in the raster line close to the image printed by ejecting the black dye ink earlier than in the raster line close to the image printed by ejecting the black pigment ink earlier. Thus, since the hue and the density of the overlapping image between the image printed at the forward movement time and the image printed at the backward movement time can be varied smoothly, the join between the image printed at the forward movement time and the image printed at the backward movement time can scarcely be noticed.

In order to set the usage rate of the black dye nozzle row Kd and the usage rate of the black pigment nozzle row Kp such that the hue and density of the overlapping image have the values between the hue and density of the image printed at the forward movement time and the hue and density of the image printed at the backward movement time, the relationship diagram (relationship expression) between the usage rates of the two nozzle rows Kd and Kp and the hues shown in FIG. 4A and the relationship diagram (relationship expression) between the usage rates of the two nozzle rows Kd and Kp and the densities shown in FIG. 4B may be created in the process of designing the printer 1. Therefore, by actually changing the usage rate of the black dye nozzle row Kd and the usage rate of the black pigment nozzle row Kp several times to print an image, the hue and the density of the image may be measured. The hue and density of the band image printed at the forward movement time and the band image printed at the backward movement time are measured in every kind of printer 1 or every printer 1. Thereafter, the usage rate of the black dye nozzle row Kd and the usage rate of the black pigment nozzle row Kp for printing the overlapping image are determined so that the hue and density of the overlapping image have the values between the hue and density of the band image printed at the forward movement time and the hue and density of the band image printed at the backward movement time, respectively, based on the relationship diagrams shown in FIGS. 4A and 4B. The usage rates determined in this manner may be stored in the memory 13 of the printer 1. Then, the controller 10 of the printer 1 or the printer driver installed in the computer 60 can create the print data (dot ON-OFF data) of the overlapping image according to the usage rate of the black dye nozzle row Kd and the usage rate of the black pigment nozzle row Kp stored in the memory 13. However, the invention is not limited thereto. The relationship diagram (see FIG. 4A) between the usage rates of the two nozzle rows Kd and Kp and the hues and the relationship diagram (see FIG. 4B) between the usage rates of the two nozzle rows Kd and Kp and the densities may be stored in the memory 13 of the printer 1. The usage rate of the black dye nozzle row Kd and the usage rate of the black pigment nozzle row Kp correspond to the densities of the image in FIG. 4B, but the invention is not limited thereto. The usage rate of the black dye nozzle row Kd and the usage rate of the black pigment nozzle row Kp may correspond to the lightness or brightness of the image.

As shown in FIG. 5, the usage rate of the black pigment nozzle row Kp is set to be higher in the raster line belonging to the overlapping image close to the image printed by ejecting the black pigment ink earlier. The usage rate of the black dye nozzle row Kd is set to be higher in the raster line belonging to the overlapping image close to the image printed by ejecting the black dye ink earlier. However, the invention is not limited thereto. All of the raster lines belonging to the overlapping image may be printed at constant usage rates. For example, the overlapping image may be printed at the constant usage rates which are the average values of the hue and density of the overlapping image between the hues and densities of the image printed when reciprocating. Then, since the overlapping image with the intermediate hue and density is formed between the image printed at the forward movement time and the image printed at the backward movement time, the boundary line between the image printed at the forward movement time and the image printed at the backward movement time can scarcely be noticed. The invention is not limited to the change in the usage rates of the two nozzle rows Kd and Kp in ever raster line. The usage rates may be changed in every plurality of raster lines.

### Other Embodiments

The above-described embodiment mainly describes the printing system including the ink jet printer, but includes disclosure of a hue-unevenness correcting method. The above-described embodiment is described to allow ready understanding of the invention, but should not be construed to limit the invention. Of course, the invention may be modified and improved without departing from the gist of the invention, and the equivalents of the invention are included in the invention. In particular, the following embodiments are included in the invention.

### Hue and Density of Overlapping Image

In the above-described embodiment, the usage rate of the black dye nozzle row Kd and the usage rate of the black pigment nozzle row Kp for printing the overlapping image are set such that both the hue and density of the overlapping image are set to have the values between the hue and density of the image printed at the forward movement time and the hue and density of the image printed at the forward movement time. However, the invention is not limited thereto. For example, even when only the density of the overlapping image is set to have the value between the density of the image printed at the forward movement time and the density of the image printed at the backward movement time, the boundary line between the images can scarcely be noticed compared to the printing method (see FIG. 3) according to the comparative example. Alternatively, even when only the hue of the overlapping image is set to have the value between the hue of the image printed at the forward movement time and the hue of the image printed at the backward movement time, the boundary line between the images can scarcely be noticed compared to the printing method according to the comparative example.

### Black Ink

In the above-described embodiment, the printer ejecting the black dye ink and the black pigment ink has been exemplified, but the invention is not limited thereto. For example, in a printer simultaneously using both dye ink and pigment ink of other colors (for example, YMC), the overlapping image may be printed by overlapping the end portion of an image printed at the forward movement time with the end portion of an image printed at the backward movement time and adjusting the usage rate of the nozzle row for the dye ink and the usage rate of the nozzle row for the pigment ink.

### Arrangement of Dye Nozzle Row and Pigment Nozzle Row

In the above-described embodiment, as shown in FIG. 2, the black pigment nozzle row Kp is delayed by the half of the nozzle pitch with respect to the black dye nozzle row Kd to print a high-resolution image rapidly. However, the invention is not limited thereto. For example, a printer in which the black pigment nozzle row Kp and the black dye nozzle row Kd are not separated from each other in the transport direction may be used. Even in this printer, the overlapping image may be printed by overlapping the end portion of an image printed at the forward movement time with the end portion of an image printed at the backward movement time and adjusting the usage rate of the nozzle row for the dye ink and the usage rate of the nozzle row for the pigment ink.

### Medium

In the above-described embodiment, when an image is printed on a plain sheet, both the dye ink and the pigment ink are used. However, the invention is not limited thereto. An image may be printed by simultaneously using both the dye ink and the pigment ink on a medium in which both the dye ink and the pigment ink are usable, as in the plain sheet.

### Printer

In the above-described embodiment, the printer repeating the image forming operation of ejecting ink droplets while moving the head 41 in the movement direction and the transport operation of transporting the medium in the transport direction intersecting the movement direction has been exemplified. However, the invention is not limited thereto. For example, a printer may be used which prints an image by repeating an operation of first transporting a continuous sheet to a print area and forming an image relative to the sheet located in the print area while moving a head to a transport direction of the sheet and an operation of moving the head in a sheet direction, and then by transporting a sheet part not subjected to the printing to the print area.

### Printing Apparatus

As the ink ejecting method, a piezoelectric method of ejecting a fluid by applying a voltage to driving elements (piezoelectric element) to expand or contract ink chambers or a thermal method of ejecting a liquid by bubbles generated in the nozzles using heating elements may be used.

The entire disclosure of Japanese Patent Application No. 2009-237534, filed Oct. 14, 2009 is expressly incorporated by reference herein.

What is claimed is:

1. A printing apparatus comprising:
first nozzles ejecting dye ink of a certain color;
second nozzles ejecting pigment ink of the certain color; and
a control unit moving the first and second nozzles relative to a medium in a movement direction and printing an image in which a first image formed by ejecting the dye ink from the first nozzles and then ejecting the pigment ink from the second nozzles and a second image formed by ejecting the pigment ink from the second nozzles and then ejecting the dye ink from the first nozzles are alternately arranged in a predetermined direction intersecting the movement direction and in which an end portion of the first image overlaps with an end portion of the second image.

2. The printing apparatus according to claim 1, further comprising:
a first nozzle row in which the first nozzles are arranged in the predetermined direction; and
a second nozzle row in which the second nozzles are arranged in the predetermined direction,
wherein the control unit repeats an ejection operation of ejecting ink from the first and second nozzles while moving the first and second nozzle rows relative to the medium in the movement direction and a transport operation of moving the first and second nozzle rows relative to the medium in the predetermined direction to print an image in which the first image formed at a predetermined position on the medium while moving the first and second nozzle rows relative to the medium from one side to the other side of the movement direction and the second image formed at a position on the medium different from the predetermined position while moving the first and second nozzle rows relative to the medium from the other side to the one side of the movement direction are alternately arranged in the predetermined direction.

3. The printing apparatus according to claim 2, wherein a usage rate of the first nozzle row and a usage rate of the second nozzle row for forming an overlapping image in which an end portion of the first image overlaps with an end portion of the second image are adjusted such that a density of the overlapping image is set to a density between a density of the first image and a density of the second image.

4. The printing apparatus according to claim 2, wherein a usage rate of the first nozzle row and a usage rate of the second nozzle row for forming: an overlapping image in which an end portion of the first image overlaps with an end portion of the second image are adjusted such that a hue of the overlapping image is set to a hue between a hue of the first image and a hue of the second image.

5. The printing apparatus according to claim 3,
wherein the usage rate of the first nozzle row for forming an image part of the first image side in the overlapping image is higher than the usage rate of the first nozzle row for forming an image part of the second image side in the overlapping image, and
wherein the usage rate of the second nozzle row for forming an image part of the second image side in the overlapping image is higher than the usage rate of the second nozzle row for forming an image part of the first image side in the overlapping image.

6. The printing apparatus according to claim 3, wherein a dot line belonging to the overlapping image and formed in the movement direction is formed, by the nozzles belonging to the first nozzle row in a certain ejection operation and the nozzles belonging to the second nozzle row in another ejection operation.

7. A printing method of controlling a printing apparatus that includes first nozzles ejecting dye ink of a certain color and second nozzles ejecting pigment ink of the certain color, the printing method comprising:
moving the first and second nozzles relative to a medium in a movement direction; and
printing an image in which a first image formed by ejecting the dye ink from the first nozzles and then ejecting the pigment ink from the second nozzles and a second image formed by ejecting the pigment ink from the second nozzles and then ejecting the dye ink from the first nozzles are alternately arranged in a predetermined direction intersecting the movement direction and in which an end portion of the first image overlaps with an end portion of the second image.

8. The printing method according to claim 7, further comprising:
repeating an ejection operation of ejecting ink from the first and second nozzles while moving a first nozzle row in which the first nozzles are arranged in the predetermined direction and a second nozzle row in which the second nozzles are arranged in the predetermined direction relative to the medium in the movement direction and a transport operation of moving the first and second nozzle rows relative to the medium in the predetermined direction; and
printing an image in which the first image formed at a predetermined position on the medium while moving the first and second nozzle rows relative to the medium from one side to the other side of the movement direction and the second image formed at a position on the medium different from the predetermined position while moving the first and second nozzle rows relative to the medium from the other side to the one side of the movement direction are alternately arranged in the predetermined direction and in which an end portion of the first image overlaps with an end portion of the second image.
